(19) United States
(12) Patent Application Publication
(10) Pub. No.: US 2026/0238998 A1
(43) Pub. Date: Aug. 13, 2026

(54) APPARATUS, METHOD, AND COMPUTER PROGRAM FOR GENERATING KEYS FOR USE WITH SIGNALLING ON TWO ACCESS PATHS

(71) Applicant: Nokia Technologies Oy, Espoo (FI)

(72) Inventors: Ranganathan MAVUREDDI DHANASEKARAN, Munich (DE); Saurabh KHARE, Bangalore (IN); Suresh P NAIR, Estero, FL (US); Jing PING, Chengdu (CN)

(21) Appl. No.: 19/474,794

(22) PCT Filed: Apr. 19, 2023
(86) PCT No.: PCT/CN2023/089315

§ 371 Date: Oct. 13, 2025

(51) Int. Cl. H04W 12/041; H04L 9/06

(52) U.S. Cl. CPC H04W 12/041; H04L 9/0618

(57) ABSTRACT

There is provided a method, apparatus, and computer program for causing an apparatus at least to perform establishing a first security context with another apparatus over a first access path between the another apparatus and the apparatus; establishing a second security context with the another apparatus over a second access path between the another apparatus and the apparatus, wherein the first and second access paths are associated with a same access type; and simultaneously maintaining the first and second security contexts.

### FIELD OF THE DISCLOSURE

The examples described herein generally relate to apparatus, methods, and computer programs, and more particularly (but not exclusively) to apparatus, methods and computer programs for apparatuses.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to a first aspect, there is provided an apparatus, the apparatus comprising means for performing: exchanging first signalling with a user equipment, the first signalling comprising a first access path identifier that identifies a first access path between the user equipment and the apparatus; exchanging second signalling with the user equipment, the second signalling comprising a second access path identifier that identifies a second access path between the user equipment and the apparatus, the first and second access paths providing dual access between the user equipment and a network; determining that the first and second access paths are associated with a first access type; respectively assigning first and second access type identifiers to the first and second access paths based on the determining and the first and second access path identifiers; using the first access type identifier to generate a first key for use with signalling on the first access path; and using the second access type identifier to generate a second key for use with signalling on the second access path.

The apparatus may comprise an access and mobility management function.

The apparatus may comprise means for: providing the first key to a first access node associated with the first access path; and providing the second key to a second access node associated with the second access path.

The first signalling may be for establishing a first non-access stratum security context, and/or the second signalling may be for establishing a second non-access stratum security context.

The first access path identifier may be at least one of: a registration identifier or a leg identifier or any other identifier.

The second access path identifier may be at least one of: a registration identifier or a leg identifier or any other identifier.

The first access path type may be at least one of: 3GPP, or non-3GPP.

The first and second access paths may belong to a same administrative domain.

According to a second aspect, there is provided an apparatus, the apparatus comprising means for performing: exchanging first signalling with a network apparatus, the first signalling comprising a first access path identifier that identifies a first access path between the network apparatus and the apparatus; exchanging second signalling with the network apparatus, the second signalling comprising a second access path identifier that identifies a second access path between the network apparatus and the apparatus, the first and second access paths providing dual access between the apparatus and a network; determining that the first and second access paths are associated with a first access type; respectively assigning first and second access type identifiers to the first and second access paths based on the determining and the first and second access path identifiers; using the first access type identifier to generate a first key for use with signalling on the first access path; and using the second access type identifier to generate a second key for use with signalling on the second access path.

The apparatus may comprise means for performing: using the first key or at least one key derived from the first key for ciphering and/or integrity protection of signalling with a first access node on the first access path.

The apparatus may comprise means for performing: using the second key or at least one key derived from the second key for ciphering and/or integrity protection of signalling with a second access node on the second access path.

The apparatus may comprise a user equipment.

The first signalling may be for establishing a first non-access stratum security context, and/or the second signalling may be for establishing a second non-access stratum security context.

The first access path identifier may be at least one of: a registration identifier or a leg identifier or any other identifier.

The second access path identifier may be at least one of: a registration identifier or a leg identifier or any other identifier.

The first access path type may be at least one of: 3GPP, or non-3GPP.

The first and second access paths may belong to a same administrative domain.

According to a third aspect, there is provided an apparatus, the apparatus comprising means for performing: exchanging first signalling with a user equipment, the first signalling comprising a first access path identifier that identifies a first access path between the user equipment and the apparatus; causing the user equipment to be authenticated to obtain a first security key for the user equipment along the first access path; exchanging second signalling with the user equipment, the second signalling comprising a second access path identifier that identifies a second access path between the user equipment and the apparatus, the first and second access paths providing dual access between the user equipment and a network; determining that the first and second access paths are associated with a first access type; determining to cause the user equipment to be authenticated over the second access based on the second access path identifier; causing the user equipment to be authenticated to obtain a second security key for the user equipment along the second access path; using the first security key to generate a first key for use with signalling on the first access path; and using the second security key to generate a second key for use with signalling on the second access path.

The apparatus may comprise an access and mobility management function.

The apparatus may comprise means for providing the first key to a first access node associated with the first access path; and providing the second key to a second access node associated with the second access path.

The apparatus may comprise means for simultaneously maintaining the first security key as part of a first security context for the user equipment, and the second security key as part of a second security context for the user equipment.

The first signalling may be for establishing a first non-access stratum security context, and/or the second signalling may be for establishing a second non-access stratum security context.

The first access path identifier may be at least one of: a registration identifier or a leg identifier or any other identifier.

The second access path identifier may be at least one of: a registration identifier or a leg identifier or any other identifier.

The first access path type may be at least one of: 3GPP, or non-3GPP.

The first and second access paths may belong to a same administrative domain.

According to a fourth aspect, there is provided an apparatus, the apparatus comprising means for performing: establishing a first security context with another apparatus over a first access path between the another apparatus and the apparatus: establishing a second security context with the another apparatus over a second access path between the another apparatus and the apparatus, wherein the first and second access paths are associated with a same access type; and simultaneously maintaining the first and second security contexts.

The apparatus may comprise means for performing: determining a first key for use with signalling a first access node associated with the first access path using the first security context; and/or determining a second key for use with signalling a second access node associated with the second access node.

The apparatus may be a user equipment or an access and mobility management function.

The first access path type may be at least one of: 3GPP, or non-3GPP.

The first and second access paths may belong to a same administrative domain.

According to a fifth aspect, there is provided an apparatus, the apparatus comprising: at least one processor; and at least one memory storing instructions that, when executed by the at least one processor, cause the apparatus at least to perform: exchanging first signalling with a user equipment, the first signalling comprising a first access path identifier that identifies a first access path between the user equipment and the apparatus; exchanging second signalling with the user equipment, the second signalling comprising a second access path identifier that identifies a second access path between the user equipment and the apparatus, the first and second access paths providing dual access between the user equipment and a network; determining that the first and second access paths are associated with a first access type; respectively assigning first and second access type identifiers to the first and second access paths based on the determining and the first and second access path identifiers; using the first access type identifier to generate a first key for use with signalling on the first access path; and using the second access type identifier to generate a second key for use with signalling on the second access path.

The apparatus may comprise an access and mobility management function.

The apparatus may be caused at least to perform: providing the first key to a first access node associated with the first access path; and providing the second key to a second access node associated with the second access path.

The first signalling may be for establishing a first non-access stratum security context, and/or the second signalling may be for establishing a second non-access stratum security context.

The first access path identifier may be at least one of: a registration identifier or a leg identifier or any other identifier.

The second access path identifier may be at least one of: a registration identifier or a leg identifier or any other identifier.

The first access path type may be at least one of: 3GPP, or non-3GPP.

The first and second access paths may belong to a same administrative domain.

According to a sixth aspect, there is provided an apparatus, the apparatus comprising: at least one processor; and at least one memory storing instructions that, when executed by the at least one processor, cause the apparatus at least to perform: exchanging first signalling with a network apparatus, the first signalling comprising a first access path identifier that identifies a first access path between the network apparatus and the apparatus; exchanging second signalling with the network apparatus, the second signalling comprising a second access path identifier that identifies a second access path between the network apparatus and the apparatus, the first and second access paths providing dual access between the apparatus and a network; determining that the first and second access paths are associated with a first access type; respectively assigning first and second access type identifiers to the first and second access paths based on the determining and the first and second access path identifiers; using the first access type identifier to generate a first key for use with signalling on the first access path; and using the second access type identifier to generate a second key for use with signalling on the second access path.

The apparatus may be caused at least to perform: using the first key or at least one key derived from the first key for ciphering and/or integrity protection of signalling with a first access node on the first access path.

The apparatus may be caused at least to perform: using the second key or at least one key derived from the second key for ciphering and/or integrity protection of signalling with a second access node on the second access path.

The apparatus may comprise a user equipment.

The first signalling may be for establishing a first non-access stratum security context, and/or the second signalling may be for establishing a second non-access stratum security context.

The first access path identifier may be at least one of: a registration identifier or a leg identifier or any other identifier.

The second access path identifier may be at least one of: a registration identifier or a leg identifier or any other identifier.

The first access path type may be at least one of: 3GPP, or non-3GPP.

The first and second access paths may belong to a same administrative domain.

According to a seventh aspect, there is provided an apparatus, the apparatus comprising: at least one processor; and at least one memory storing instructions that, when executed by the at least one processor, cause the apparatus at least to perform: exchanging first signalling with a user equipment, the first signalling comprising a first access path identifier that identifies a first access path between the user equipment and the apparatus; causing the user equipment to be authenticated to obtain a first security key for the user equipment along the first access path; exchanging second signalling with the user equipment, the second signalling comprising a second access path identifier that identifies a second access path between the user equipment and the apparatus, the first and second access paths providing dual access between the user equipment and a network; determining that the first and second access paths are associated with a first access type; determining to cause the user equipment to be authenticated over the second access based on the second access path identifier; causing the user equipment to be authenticated to obtain a second security key for the user equipment along the second access path; using the first security key to generate a first key for use with signalling on the first access path; and using the second security key to generate a second key for use with signalling on the second access path.

The apparatus may comprise an access and mobility management function.

The apparatus may be caused at least to perform: providing the first key to a first access node associated with the first access path; and providing the second key to a second access node associated with the second access path.

The apparatus may be caused at least to perform simultaneously maintaining the first security key as part of a first security context for the user equipment, and the second security key as part of a second security context for the user equipment.

The first signalling may be for establishing a first non-access stratum security context, and/or the second signalling may be for establishing a second non-access stratum security context.

The first access path identifier may be at least one of: a registration identifier or a leg identifier or any other identifier.

The second access path identifier may be at least one of: a registration identifier or a leg identifier or any other identifier.

The first access path type may be at least one of: 3GPP, or non-3GPP.

The first and second access paths may belong to a same administrative domain.

According to an eighth aspect, there is provided an apparatus, the apparatus comprising: at least one processor; and at least one memory storing instructions that, when executed by the at least one processor, causes the apparatus at least to perform: establishing a first security context with another apparatus over a first access path between the another apparatus and the apparatus: establishing a second security context with the another apparatus over a second access path between the another apparatus and the apparatus, wherein the first and second access paths are associated with a same access type; and simultaneously maintaining the first and second security contexts.

The apparatus may be caused at least to perform: determining a first key for use with signalling a first access node associated with the first access path using the first security context; and/or determining a second key for use with signalling a second access node associated with the second access node.

The apparatus may be a user equipment or an access and mobility management function.

The first access path type may be at least one of: 3GPP, or non-3GPP.

The first and second access paths may belong to a same administrative domain.

According to a ninth aspect, there is provided a method for an apparatus, the method comprising: exchanging first signalling with a user equipment, the first signalling comprising a first access path identifier that identifies a first access path between the user equipment and the apparatus; exchanging second signalling with the user equipment, the second signalling comprising a second access path identifier that identifies a second access path between the user equipment and the apparatus, the first and second access paths providing dual access between the user equipment and a network; determining that the first and second access paths are associated with a first access type; respectively assigning first and second access type identifiers to the first and second access paths based on the determining and the first and second access path identifiers; using the first access type identifier to generate a first key for use with signalling on the first access path; and using the second access type identifier to generate a second key for use with signalling on the second access path.

The apparatus may comprise an access and mobility management function.

The method may comprise: providing the first key to a first access node associated with the first access path; and providing the second key to a second access node associated with the second access path.

The first signalling may be for establishing a first non-access stratum security context, and/or the second signalling may be for establishing a second non-access stratum security context.

The first access path identifier may be at least one of: a registration identifier or a leg identifier or any other identifier.

The second access path identifier may be at least one of: a registration identifier or a leg identifier or any other identifier.

The first access path type may be at least one of: 3GPP, or non-3GPP.

The first and second access paths may belong to a same administrative domain.

According to a tenth aspect, there is provided a method for an apparatus, the method comprising: exchanging first signalling with a network apparatus, the first signalling comprising a first access path identifier that identifies a first access path between the network apparatus and the apparatus; exchanging second signalling with the network apparatus, the second signalling comprising a second access path identifier that identifies a second access path between the network apparatus and the apparatus, the first and second access paths providing dual access between the apparatus and a network; determining that the first and second access paths are associated with a first access type; respectively assigning first and second access type identifiers to the first and second access paths based on the determining and the first and second access path identifiers; using the first access type identifier to generate a first key for use with signalling on the first access path; and using the second access type identifier to generate a second key for use with signalling on the second access path.

The method may comprise: using the first key or at least one key derived from the first key for ciphering and/or integrity protection of signalling with a first access node on the first access path.

The method may comprise: using the second key or at least one key derived from the second key for ciphering and/or integrity protection of signalling with a second access node on the second access path.

The apparatus may comprise a user equipment.

The first signalling may be for establishing a first non-access stratum security context, and/or the second signalling may be for establishing a second non-access stratum security context.

The first access path identifier may be at least one of: a registration identifier or a leg identifier or any other identifier.

The second access path identifier may be at least one of: a registration identifier or a leg identifier or any other identifier.

The first access path type may be at least one of: 3GPP, or non-3GPP.

The first and second access paths may belong to a same administrative domain.

According to an eleventh aspect, there is provided a method for an apparatus, the method comprising: exchanging first signalling with a user equipment, the first signalling comprising a first access path identifier that identifies a first access path between the user equipment and the apparatus; causing the user equipment to be authenticated to obtain a first security key for the user equipment along the first access path; exchanging second signalling with the user equipment, the second signalling comprising a second access path identifier that identifies a second access path between the user equipment and the apparatus, the first and second access paths providing dual access between the user equipment and a network; determining that the first and second access paths are associated with a first access type; determining to cause the user equipment to be authenticated over the second access based on the second access path identifier; causing the user equipment to be authenticated to obtain a second security key for the user equipment along the second access path; using the first security key to generate a first key for use with signalling on the first access path; and using the second security key to generate a second key for use with signalling on the second access path.

The apparatus may comprise an access and mobility management function.

The method may comprise: providing the first key to a first access node associated with the first access path; and providing the second key to a second access node associated with the second access path.

The method may comprise simultaneously maintaining the first security key as part of a first security context for the user equipment, and the second security key as part of a second security context for the user equipment.

The first signalling may be for establishing a first non-access stratum security context, and/or the second signalling may be for establishing a second non-access stratum security context.

The first access path identifier may be at least one of: a registration identifier or a leg identifier or any other identifier.

The second access path identifier may be at least one of: a registration identifier or a leg identifier or any other identifier.

The first access path type may be at least one of: 3GPP, or non-3GPP.

The first and second access paths may belong to a same administrative domain.

According to a twelfth aspect, there is provided a method for an apparatus, the method comprising: establishing a first security context with another apparatus over a first access path between the another apparatus and the apparatus: establishing a second security context with the another apparatus over a second access path between the another apparatus and the apparatus, wherein the first and second access paths are associated with a same access type; and simultaneously maintaining the first and second security contexts.

The method may comprise: determining a first key for use with signalling a first access node associated with the first access path using the first security context; and/or determining a second key for use with signalling a second access node associated with the second access node.

The apparatus may be a user equipment or an access and mobility management function.

The first access path type may be at least one of: 3GPP, or non-3GPP.

The first and second access paths may belong to a same administrative domain.

According to a thirteenth aspect, there is provided an apparatus, the apparatus comprising: exchanging circuitry for exchanging first signalling with a user equipment, the first signalling comprising a first access path identifier that identifies a first access path between the user equipment and the apparatus; exchanging circuitry for exchanging second signalling with the user equipment, the second signalling comprising a second access path identifier that identifies a second access path between the user equipment and the apparatus, the first and second access paths providing dual access between the user equipment and a network; determining circuitry for determining that the first and second access paths are associated with a first access type; assigning circuitry for respectively assigning first and second access type identifiers to the first and second access paths based on the determining and the first and second access path identifiers; using circuitry for using the first access type identifier to generate a first key for use with signalling on the first access path; and using circuitry for using the second access type identifier to generate a second key for use with signalling on the second access path.

The apparatus may comprise an access and mobility management function.

The apparatus may comprise: providing circuitry for providing the first key to a first access node associated with the first access path; and providing circuitry for providing the second key to a second access node associated with the second access path.

The first signalling may be for establishing a first non-access stratum security context, and/or the second signalling may be for establishing a second non-access stratum security context.

The first access path identifier may be at least one of: a registration identifier or a leg identifier or any other identifier.

The second access path identifier may be at least one of: a registration identifier or a leg identifier or any other identifier.

The first access path type may be at least one of: 3GPP, or non-3GPP.

The first and second access paths may belong to a same administrative domain.

According to a fourteenth aspect, there is provided an apparatus, the apparatus comprising means for performing: exchanging circuitry for exchanging first signalling with a network apparatus, the first signalling comprising a first access path identifier that identifies a first access path between the network apparatus and the apparatus; exchanging circuitry for exchanging second signalling with the network apparatus, the second signalling comprising a second access path identifier that identifies a second access path between the network apparatus and the apparatus, the first and second access paths providing dual access between the apparatus and a network; determining circuitry for determining that the first and second access paths are associated with a first access type; assigning circuitry for respectively assigning first and second access type identifiers to the first and second access paths based on the determining and the first and second access path identifiers; using circuitry for using the first access type identifier to generate a first key for use with signalling on the first access path; and using circuitry for using the second access type identifier to generate a second key for use with signalling on the second access path.

The apparatus may comprise: using circuitry for using the first key or at least one key derived from the first key for ciphering and/or integrity protection of signalling with a first access node on the first access path.

The apparatus may comprise: using circuitry for using the second key or at least one key derived from the second key for ciphering and/or integrity protection of signalling with a second access node on the second access path.

The apparatus may comprise a user equipment.

The first signalling may be for establishing a first non-access stratum security context, and/or the second signalling may be for establishing a second non-access stratum security context.

The first access path identifier may be at least one of: a registration identifier or a leg identifier or any other identifier.

The second access path identifier may be at least one of: a registration identifier or a leg identifier or any other identifier.

The first access path type may be at least one of: 3GPP, or non-3GPP.

The first and second access paths may belong to a same administrative domain.

According to a fifteenth aspect, there is provided an apparatus, the apparatus comprising: exchanging circuitry for exchanging first signalling with a user equipment, the first signalling comprising a first access path identifier that identifies a first access path between the user equipment and the apparatus; causing circuitry for causing the user equipment to be authenticated to obtain a first security key for the user equipment along the first access path; exchanging circuitry for exchanging second signalling with the user equipment, the second signalling comprising a second access path identifier that identifies a second access path between the user equipment and the apparatus, the first and second access paths providing dual access between the user equipment and a network; determining circuitry for determining that the first and second access paths are associated with a first access type; determining circuitry for determining to cause the user equipment to be authenticated over the second access based on the second access path identifier; causing circuitry for causing the user equipment to be authenticated to obtain a second security key for the user equipment along the second access path; using circuitry for using the first security key to generate a first key for use with signalling on the first access path; and using circuitry for using the second security key to generate a second key for use with signalling on the second access path.

The apparatus may comprise an access and mobility management function.

The apparatus may comprise: providing circuitry for providing the first key to a first access node associated with the first access path; and providing circuitry for providing the second key to a second access node associated with the second access path.

The apparatus may comprise maintaining circuitry for simultaneously maintaining the first security key as part of a first security context for the user equipment, and the second security key as part of a second security context for the user equipment.

The first signalling may be for establishing a first non-access stratum security context, and/or the second signalling may be for establishing a second non-access stratum security context.

The first access path identifier may be at least one of: a registration identifier or a leg identifier or any other identifier.

The second access path identifier may be at least one of: a registration identifier or a leg identifier or any other identifier.

The first access path type may be at least one of: 3GPP, or non-3GPP.

The first and second access paths may belong to a same administrative domain.

According to a sixteenth aspect, there is provided an apparatus, the apparatus comprising: establishing circuitry for establishing a first security context with another apparatus over a first access path between the another apparatus and the apparatus: establishing circuitry for establishing a second security context with the another apparatus over a second access path between the another apparatus and the apparatus, wherein the first and second access paths are associated with a same access type; and maintaining circuitry for simultaneously maintaining the first and second security contexts.

The apparatus may comprise: determining circuitry for determining a first key for use with signalling a first access node associated with the first access path using the first security context; and/or determining circuitry for determining a second key for use with signalling a second access node associated with the second access node.

The apparatus may be a user equipment or an access and mobility management function.

The first access path type may be at least one of: 3GPP, or non-3GPP.

The first and second access paths may belong to a same administrative domain.

According to a seventeenth aspect, there is provided non-transitory computer readable medium comprising program instructions for causing an apparatus to perform: exchanging first signalling with a user equipment, the first signalling comprising a first access path identifier that identifies a first access path between the user equipment and the apparatus; exchanging second signalling with the user equipment, the second signalling comprising a second access path identifier that identifies a second access path between the user equipment and the apparatus, the first and second access paths providing dual access between the user equipment and a network; determining that the first and second access paths are associated with a first access type; respectively assigning first and second access type identifiers to the first and second access paths based on the determining and the first and second access path identifiers; using the first access type identifier to generate a first key for use with signalling on the first access path; and using the second access type identifier to generate a second key for use with signalling on the second access path.

The apparatus may comprise an access and mobility management function.

The apparatus may be caused at least to perform: providing the first key to a first access node associated with the first access path; and providing the second key to a second access node associated with the second access path.

The first signalling may be for establishing a first non-access stratum security context, and/or the second signalling may be for establishing a second non-access stratum security context.

The first access path identifier may be at least one of: a registration identifier or a leg identifier or any other identifier.

The second access path identifier may be at least one of: a registration identifier or a leg identifier or any other identifier.

The first access path type may be at least one of: 3GPP, or non-3GPP.

The first and second access paths may belong to a same administrative domain.

According to an eighteenth aspect, there is provided non-transitory computer readable medium comprising program instructions for causing an apparatus to perform: exchanging first signalling with a network apparatus, the first signalling comprising a first access path identifier that identifies a first access path between the network apparatus and the apparatus; exchanging second signalling with the network apparatus, the second signalling comprising a second access path identifier that identifies a second access path between the network apparatus and the apparatus, the first and second access paths providing dual access between the apparatus and a network; determining that the first and second access paths are associated with a first access type; respectively assigning first and second access type identifiers to the first and second access paths based on the determining and the first and second access path identifiers; using the first access type identifier to generate a first key for use with signalling on the first access path; and using the second access type identifier to generate a second key for use with signalling on the second access path.

The apparatus may be caused at least to perform: using the first key or at least one key derived from the first key for ciphering and/or integrity protection of signalling with a first access node on the first access path.

The apparatus may be caused at least to perform: using the second key or at least one key derived from the second key for ciphering and/or integrity protection of signalling with a second access node on the second access path.

The apparatus may comprise a user equipment.

The first signalling may be for establishing a first non-access stratum security context, and/or the second signalling may be for establishing a second non-access stratum security context.

The first access path identifier may be at least one of: a registration identifier or a leg identifier or any other identifier.

The second access path identifier may be at least one of: a registration identifier or a leg identifier or any other identifier.

The first access path type may be at least one of: 3GPP, or non-3GPP.

The first and second access paths may belong to a same administrative domain.

According to a nineteenth aspect, there is provided non-transitory computer readable medium comprising program instructions for causing an apparatus to perform: exchanging first signalling with a user equipment, the first signalling comprising a first access path identifier that identifies a first access path between the user equipment and the apparatus; causing the user equipment to be authenticated to obtain a first security key for the user equipment along the first access path; exchanging second signalling with the user equipment, the second signalling comprising a second access path identifier that identifies a second access path between the user equipment and the apparatus, the first and second access paths providing dual access between the user equipment and a network; determining that the first and second access paths are associated with a first access type; determining to cause the user equipment to be authenticated over the second access based on the second access path identifier; causing the user equipment to be authenticated to obtain a second security key for the user equipment along the second access path; using the first security key to generate a first key for use with signalling on the first access path; and using the second security key to generate a second key for use with signalling on the second access path.

The apparatus may comprise an access and mobility management function.

The apparatus may be caused at least to perform: providing the first key to a first access node associated with the first access path; and providing the second key to a second access node associated with the second access path.

The apparatus may be caused at least to perform simultaneously maintaining the first security key as part of a first security context for the user equipment, and the second security key as part of a second security context for the user equipment.

The first signalling may be for establishing a first non-access stratum security context, and/or the second signalling may be for establishing a second non-access stratum security context.

The first access path identifier may be at least one of: a registration identifier or a leg identifier or any other identifier.

The second access path identifier may be at least one of: a registration identifier or a leg identifier or any other identifier.

The first access path type may be at least one of: 3GPP, or non-3GPP.

The first and second access paths may belong to a same administrative domain.

According to a twentieth aspect, there is provided non-transitory computer readable medium comprising program instructions for causing an apparatus to perform: establishing a first security context with another apparatus over a first access path between the another apparatus and the apparatus: establishing a second security context with the another apparatus over a second access path between the another apparatus and the apparatus, wherein the first and second access paths are associated with a same access type; and simultaneously maintaining the first and second security contexts.

The apparatus may be caused at least to perform: determining a first key for use with signalling a first access node associated with the first access path using the first security context; and/or determining a second key for use with signalling a second access node associated with the second access node.

The apparatus may be a user equipment or an access and mobility management function.

The first access path type may be at least one of: 3GPP, or non-3GPP.

The first and second access paths may belong to a same administrative domain.

According to a twenty first aspect, there is provided a computer program product stored on a medium that may cause an apparatus to perform any method as described herein.

According to a twenty second aspect, there is provided an electronic device that may comprise apparatus as described herein.

According to a twenty third aspect, there is provided a chipset that may comprise an apparatus as described herein.

### BRIEF DESCRIPTION OF FIGURES

Some examples, will now be described, merely by way of illustration only, with reference to the accompanying drawings in which:

FIG. 1 shows a schematic representation of a 5G system;

FIG. 2 shows a schematic representation of a network apparatus;

FIG. 3 shows a schematic representation of a user equipment;

FIG. 4 illustrates signalling;

FIGS. 5 to 6 illustrate example signalling; and

FIGS. 7 to 10 illustrate example operations that may be performed by apparatus described herein.

### DETAILED DESCRIPTION

The following describes operations related to key generation when a user equipment (UE) registers to a network via multiple access network nodes. The multiple access network nodes may be multiple access network nodes associated with a same type of access (e.g., all 3GPP or all non-3GPP). The multiple access network nodes may all be associated with a same administrative domain (e.g., via a same Public Land Mobile Network (PLMN)), although it is understood that they may belong to differing administrative domains in some examples (e.g., where an appropriate interworking agreement exists).

In the following description of examples, certain aspects are explained with reference to devices that are often capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems (for example, current 6G proposals, IEEE 802.11, etc.).

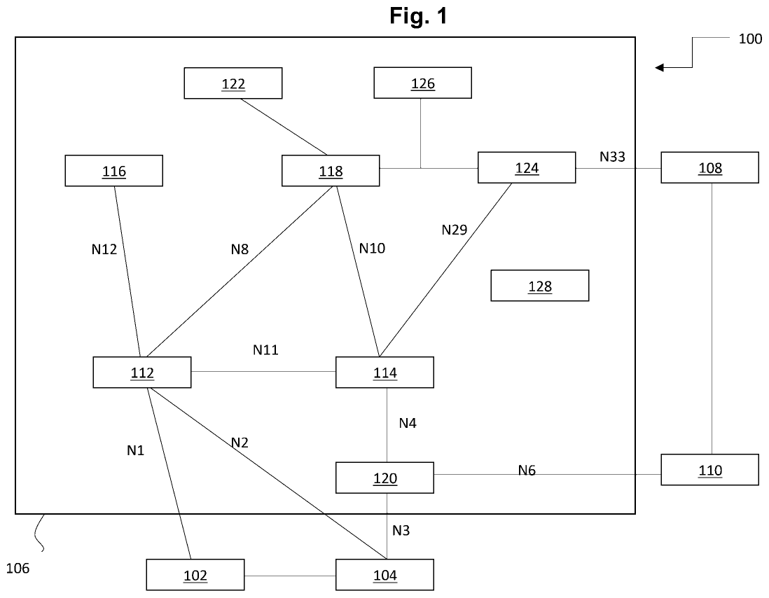

Before describing in detail the examples, certain general principles of a 5G wireless communication system are briefly explained with reference to FIGS. 1 to 3.

FIG. 1 shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

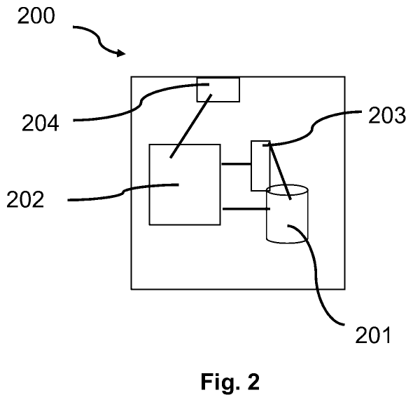

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR, and so forth. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions. References to “code” or “instructions” herein are understood to refer to software code, and vice versa.

The station of the access system may be categorised into two different types: distributed units (DUs), and centralised units (CUs).

A DU provides access node support for lower layers of the protocol stack (such as, for example, the radio link control (RLC), medium access control (MAC), and/or physical layer protocol layers). Each DU is able to support one or more cells, while each cell is able to support one or more beams.

A CU can support multiple DUs, and provides access node support for higher layers of the protocol stack within an access node (such as, for example, packet data convergence protocol (PDCP), service data adaptation protocol (SDAP), and/or radio resource control (RRC) protocol layers). The interface between a CU and a DU is labelled as an F1 interface. There is a single CU for each gNB, and CU's belonging to multiple gNB may be implemented using a shared hardware platform.

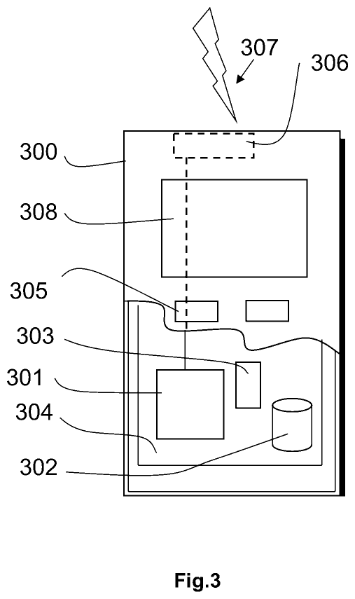

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is referred to as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. As described herein, the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be arranged internally or externally to the wireless device.

A wireless device is typically provided with at least one data processing entity 301, at least one memory 302 and other possible components 303 for use in software code and hardware aided execution of Tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface such as keypad 305, voice commands, touch sensitive screen or pad, combinations thereof or the like. A display 308, a speaker and a microphone can be also provided. Furthermore, a wireless communication device may comprise appropriate connectors (either wired or wireless) to other devices and/or for connecting external accessories, for example hands-free equipment, thereto.

3GPP has issued a number of releases (Rel) for defining operating communication protocols related to a communications network. Currently, objectives and work are being set in relation to Release 19 (Rel. 19).

One of the study items that's been approved for study for Rel.19 relates to Upper layer traffic steering, switching and split over dual 3GPP access.

5GS supports certain functionalities for providing multi-access data connectivity at the upper layers (e.g., above a Radio Access Network (RAN) level.

Multi-access data connectivity refers to the possibility of using two access network paths and two independent user plane tunnels between RAN and an anchor user plane function in 5GC for exchanging user-plane traffic between the UE and a data network.

For example, an Access Traffic Steering, Switching and Splitting (ATSSS) function supports traffic steering, split and switching across a 3GPP access path and a non-3GPP access path.

Multi-access data connectivity may be useful in a variety of situations in which it is desired to distribute and/or aggregate the traffic across two 3GPP access paths. These may include, for example:
When two 3GPP access paths are in the same administrative domain (e.g., the same Public Land Mobile Network (PLMN), e.g., a first access path using a Long Term Evolution (LTE) or Enhanced Packet Core (EPC) network, and a second access path using NR/5GC, or two paths using 3GPP non-terrestrial networks (NTN) access (e.g., over a low earth orbit (LEO) satellite and a Medium Earth Orbit (MEO) or Geostationary Earth Orbit (GEO) satellite); and/or.
Two 3GPP access paths over two different administrative domains of a same type) (e.g., over two different PLMNs), or between two administrative domains of a different type (e.g., between a PLMN and a non-public network (NPN)). As an example, there may be two 3GPP terrestrial access paths that use a same radio access technology (RAT) (e.g., two NR paths, and/or two NTN paths), and/or that use different RATs (e.g., NR and LTE).

In such scenarios, it may be beneficial to enable additional 5GS mechanisms to provide flexible user plane traffic aggregation, steering and switching for improving at least one of: access and network resources utilization, capacity, coverage, reliability and/or quality of experience. These 5GS mechanisms may be under the control of an operator of a mobile network (e.g., via a defined operator policy). Such additional 5GS mechanisms may be quite helpful when RAN-based mechanisms are unavailable and/or suitable.

For example, for the scenarios involving two of the same administrative domains (e.g., for two-PLMN scenarios), RAN sharing may not be in place. As another example, for single administrative domain deployments where NR and LTE multi-RAT Dual Connectivity (MR-DC) may be unsuitable. As another example, for single administrative domain deployments, inter-NTN dual connectivity may not be supported.

For the deployment scenarios involving interworking between two networks associated with respective administrative domains (e.g., between two of the same administrative domains (e.g., two PLMNs and/or between two different administrative domains (e.g., PLMN plus NPN), the two networks can be assumed to be managed by the same network operator or by different partner network operators having some business agreement in place. In the latter case, inter-network operator agreements may comprise appropriate incentives and policies on how traffic is to be managed and routed across the networks.

Some more specific examples of use cases comprise:
Terrestrial access and Satellite access (whether via a single or multiple administrative domains): In this case, extra resources available via the NTN of the satellite network can be used to extend capacity/throughput of the terrestrial network, or vice versa. The opportunity to use traffic aggregation (and/or selection and/or switch between a non-terrestrial network and a terrestrial network) can be based on demand and/or temporary coverage situations. This scenario may occur, for example, UEs located on a train, cruise-ship, or plane that is normally served by an NTN, which later arrive at a stopover region where dual NTN and terrestrial coverage is available.
Dual-satellite access (same or different PLMN): In this case, traffic aggregation and/or split across a non-terrestrial network and a terrestrial network can be used to expand bandwidth/throughput through multi satellite access, e.g., over both a LEO network and a MEO or GEO network. Steering and switch of traffic over different type of satellite accesses may be controlled by, for example, using application delay or bandwidth requirements, LEO discontinuous coverage, etc.
Local dual-terrestrial connectivity (e.g., PLMN1 plus PLMN2 or NPN): This use case may occur in specific areas or premises (e.g., in a stadium during high-data traffic events). In such cases, available resources from a local network (e.g., NPN or PLMN2) can be used to provide extra capacity to a wide-area PLMN1 network, or vice versa. Similar scenarios may apply in other local environments, e.g., campus, enterprise, factory, home.

Certain provisions have been made with respect to existing requirements and gaps in 3GPP specifications (e.g., from 3GPP TS 22.261 V19.2.0) that cover general multi-access and multi-network connectivity features.

For example, Section 6.3 of 3GPP TS 22.261 relates to multiple access technologies, and covers support of simultaneous data transmission via different access technologies (e.g., NR, E-UTRA, non-3GPP, etc.).

Further, Section 6.18 of 3GPP TS 22.261 relates to multi-network connectivity and service across operators, and covers simultaneous connectivity to multiple serving networks operated by different operators. Other multi-network connection requirements can be found, for example, in Section 6.1 (Network slicing) and Section 6.41 (Providing Access to Local Services (PALS)) of 3GPP TS 22.261.

The requirements comprised in these Sections largely focus on different services and/or applications over different networks. It does not cover the multi-network connectivity for the same data session.

The new use cases and potential requirements to be studied therefore relate to add support of upper layer traffic steering, split and switching over dual 3GPP access, as per objectives outlined below.

In particular, it is directed towards studying additional use cases and potential service requirements that could benefit from 5GS support of upper layer steering, split and switching of UE's traffic (e.g. pertaining to the same data session) across two 3GPP access links, assuming only single subscription to a PLMN, including the following scenarios:
Single PLMN, PLMN plus (standalone) NPN, two PLMNs
Same or different 3GPP RATs (NR or NTN, plus one of NR, NTN or LTE, where NTN refers to NR-based satellite access, including different orbits (e.g., GEO/MEO/LEO)).

As mentioned above, for the PLMN plus PLMN or NPN scenarios, the two networks can be managed by the same operator or by different operators (assumed to have a business agreement among them).

One of the important issues being considered in relation to a UE supporting connectivity to a network via multiple network accesses relates to establishing a security context for the multiple network access paths used for those connections.

Security contexts for use in 3GPP are currently described in Sections 6.3 and 6.9 of 3GPP TS 33.501 V18.1.0. Under this Section, it is described that whenever an initial access stratum (AS) security context is to be established between a UE and an access network node (e.g., a gNB), an AMF and the UE each independently derive a key (K_{gNB}) and a “Next Hop” parameter using another key (K_{AMF}) that is associated with a non-access stratum (NAS) security context. The AMF may provide the derived key K_{gNB} to the access network node. This derived key may be used for deriving further keys for encrypting and/or integrity protection signalling between the access network node and the UE, and/or for verifying the UE.

For example, Section 6.3.2.2 of TS 33.501 relates to multiple registrations in the same PLMN.

Under this Section, when a UE is registered in the same AMF in a same PLMN serving network over both 3GPP and non-3GPP accesses, the UE establishes two (respective) non-access stratum (NAS) connections with the network. An access stratum (AS) level security mode procedure configures AS security (e.g., security parameters for use in RRC and user-plane signalling), and the NAS level security mode procedure configures NAS security.

In more detail, upon receiving a registration request message, the AMF checks whether the UE is authenticated by the network. The AMF may decide to skip a new authentication run in case there is an available 5G security context for this UE by means of a 5G Globally Unique Temporary Identifier (5G-GUTI), e.g., when the UE successfully registered to 3GPP access. When there is no available 5G security context for this UE, the AMF establishes a 5G NAS security context. The 5G NAS security context may comprise a key for the AMF (K_{AMF}) with an associated key set identifier, the UE security capabilities, and/or uplink and downlink NAS COUNT values, where an NAS COUNT value corresponds to a sequence number for use in ciphering and/or integrity protection.

Each 5G NAS security context is associated with two separate counters (“NAS COUNT”) per access type in the same administrative domain: one related to uplink NAS messages and one related to downlink NAS messages. If the 5G NAS security context is used for access via both 3GPP and non-3GPP access in the same PLMN, there are two NAS COUNT counter pairs associated with the 5G NAS security context. NAS COUNT is used by the NAS layer for at least one of: ciphering, integrity protection, or verification. NAS COUNT values are separately maintained by a UE and by an AMF.

When the UE registers to a same AMF via a non-3GPP access, the AMF can decide not to run a new authentication if it has an available security context to use. In this case, the UE may directly take into use any available common 5G NAS security context and use it to protect the registration over the non-3GPP access.

If there are stored NAS counts for the non-3GPP access for the PLMN in the UE, then the stored NAS counts for the non-3GPP access for the PLMN may be used to protect the registration over the non-3GPP access. Otherwise, the common 5G NAS security context may be taken into use for the first time (partial) over non-3GPP access. In this case, an uplink NAS COUNT value and a downlink NAS COUNT value for the non-3GPP access is set to zero by the UE before the UE is taking the 5G NAS security context into use over non 3GPP access.

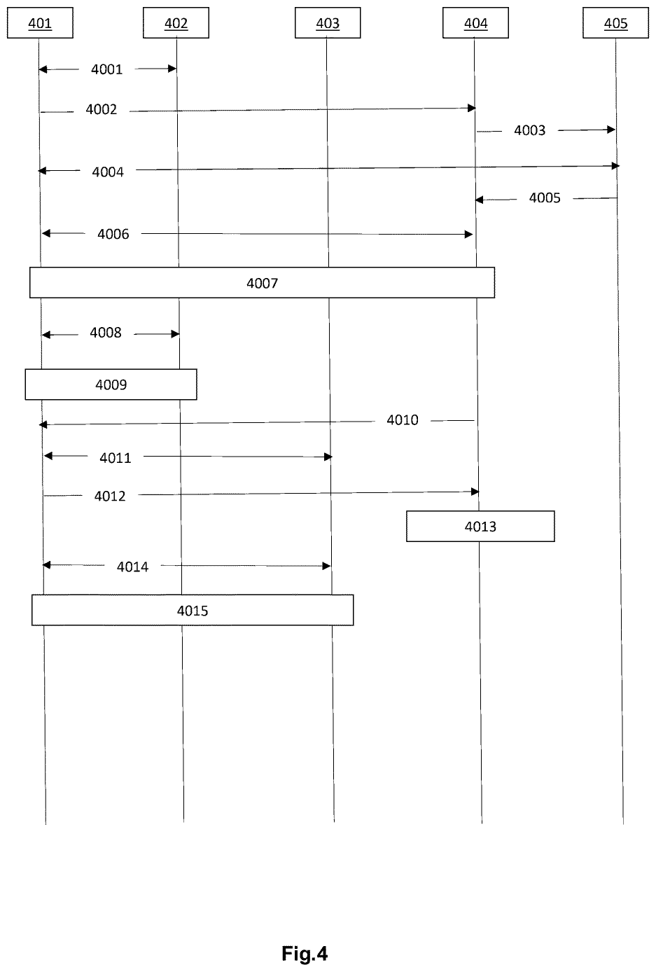

An example of a UE supporting connectivity over two 3GPP accesses at the same time is illustrated with respect to FIG. 4. The two different 3GPP RANs may support different frequency bands or different radio access technologies.

FIG. 4 illustrates signalling that may be performed between a UE 401, a first RAN node 402, a second RAN node 403, an AMF 404, and a home network 405. The first and second RAN nodes are illustrated as belonging to a same PLMN.

During 4001, the UE 401 and the first RAN node 402 exchange signalling. This signalling may establish a radio resource control (RRC) connection between the UE 401 and the first RAN node 402.

During 4002, the UE 401 may signal the AMF 404. This signalling may comprise a registration request for registering with the home network 405.

During 4003, the AMF 404 signals the home network 405. This signalling may comprise an authentication request for authenticating the UE 401.

During 4004, the home network 405 and the UE 401 exchange signalling. This signalling may comprise signalling for authenticating the UE 401 (e.g., signalling related to Authentication and Key Agreement (AKA)).

During 4005, the home network 405 signals the AMF 404. This signaling may comprise a response to the authentication request of 4003. For example, this signalling may indicate that the UE 401 has been authenticated.

During 4006, the UE 401 and the AMF 404 exchange signalling. This signalling may comprise signalling relating to a security procedure (e.g., to an NAS security procedure).

During 4007, as a result of the security procedure of 4006, each of the UE 401 and the AMF 404 are storing keys (e.g., K_{AMF} and K_{NAS}) resulting from the signalling of 4006.

During 4008, the UE 401 and the first RAN node 402 exchange signalling. This signalling may comprise signalling relating to an access stratum (AS) security procedure.

During 4009, the UE 401 and the first RAN node 402 each have keys stored (e.g., K_{gNB}, K_{RRC}, and K_{UP}) resulting from the security procedure of 4008. At least one of these keys may be generated by the AMF 404 and the UE 401. At least one of these keys may be generated independently by each of the AMF 404 and the UE 401. At least one of these keys may be generated using another key, such as K_{AMF}. The keys generated by the AMF may be provided to the first RAN node 402. The key generation may use analogous signalling to that described in, for example, Section 6 of 3GPP TS 33.501 V18.1.0.

During 4010, the AMF 404 signals the UE 401. This signalling may be a response to the signalling of 4002. For example, this signalling may comprise, for example, a registration accept message.

The operations of 4001 to 4010 are performed in respect of a first 3GPP access. In contrast, the operations of 4011 to 4015 are performed in respect of a second 3GPP access.

During 4011, the UE 401 and the second RAN node 403 exchange signalling. This signalling may establish an RRC connection between the UE 401 and the second RAN node 403.

During 4012, the UE 401 signals the AMF 404. This signalling may comprise a registration request for registering the UE 401 with the home network 405.

During 4013, the AMF 404 determines that the AMF 404 already comprises a security NAS context for the UE 401. Consequently, the AMF 404 determines not to trigger authentication for a second access with the home network 405 in response to the signalling of 4012.

During 4014, the UE 401 exchanges signalling with the second RAN node 403. This signalling may comprise signalling relating to an access stratum (AS) security procedure.

During 4015, the UE 401 and the second RAN node 403 each have keys stored (e.g., K_{gNB}, K_{RRC}, and K_{UP}) resulting from the security procedure of 4015. At least one of these keys may be generated by the AMF 404 and the UE 401. At least one of these keys may be generated independently by each of the AMF 404 and the UE 401. At least one of these keys may be generated using another key, such as K_{AMF}. The keys generated by the AMF may be provided to the second RAN node 403. The key generation may use analogous signalling to that described in, for example, Section 6 of 3GPP TS 33.501 V18.1.0.

There is no differentiation of keys as the AMF key is the same for both the first and second network nodes, and the rest of the parameters used for determining these AS keys may be the same for both access network nodes.

Therefore, under this procedure, the same access stratum security credentials exist at two separate RAN entities. However, sharing the same security credentials at different entities may lead to security vulnerabilities.

The following aims to address at least one of the problems associated with security contexts when the UE simultaneously maintains multiple connections to a network via respective access network paths.

In a first example, the UE is configured to use different access path identifiers when signalling registration requests via different access networks, and the receiving AMF determines, based on whether the received access path identifiers are different for a same UE, whether to initiate generation of new NAS keys for a latter received registration request for a same UE. Example access path identifiers comprise at least one of a registration identifier and/or a leg identifier (which identifies an access leg).

For brevity and clarity, references in the following to any of a registration identifier and/or a leg identifier and/or the like in examples, may be understood more generally to be an identifier that respectively identifies an access path and/or an access network node via which the UE signal(s) the network.

For example, in this first example, when a UE requests registration with Reg Id=2 to an administrative domain via a different RAN but to a same AMF after first requesting registration with Reg Id=1 via a first RAN of the same administrative domain, then the AMF ensures that authentication is requested for second access network. AMF should be able to differentiate second connection via Reg Id. With this approach, access keys at a home network (HN), serving network (SN), and/or access network (AN) for the different access networks will be different.

This process is further illustrated with respect to FIG. 5.

FIG. 5 illustrates signalling that may be performed between a UE 501, a first RAN node 502, a second RAN node 503, an AMF 504, and a home network 505. The first and second RAN nodes are illustrated as belonging to a same PLMN. The first RAN node 502 is associated with a first 3GPP access. The second RAN node 503 is associated with a second 3GPP access.

During 5001, the UE 501 and the first RAN node 502 exchange signalling. This signalling may establish a radio resource control (RRC) connection between the UE 501 and the first RAN node 502.

During 5002, the UE 501 may signal the AMF 504. This signalling may comprise a registration request for registering with the home network 505. This registration request may comprise a first registration identifier.

During 5003, the AMF 504 signals the home network 505. This signalling may comprise an authentication request for authenticating the UE 501.

During 5004, the home network 505 and the UE 501 exchange signalling. This signalling may comprise signalling for authenticating the UE 501 (e.g., signalling related to Authentication and Key Agreement (AKA)).

During 5005, the home network 505 signals the AMF 504. This signaling may comprise a response to the authentication request of 5003. For example, this signalling may indicate that the UE 501 has been authenticated.

During 5006, the UE 501 and the AMF 504 exchange signalling. This signalling may comprise signalling relating to a security procedure (e.g., to an NAS security procedure).

During 5007, as a result of the security procedure of 5006, each of the UE 501 and the AMF 504 generate and store keys (e.g., K_{AMF1} and K_{NAS1}) resulting from the signalling of 5006.

During 5008, the UE 501 and the first RAN node 502 exchange signalling. This signalling may comprise signalling relating to an access stratum (AS) security procedure.

During 5009, the UE 501 and the first RAN node 502 store keys (e.g., K_{gNB1}, K_{RRC1}, and K_{UP1}) resulting from the security procedure of 5008. At least one of these keys may be generated by the AMF 504 and the UE 501. At least one of these keys may be generated independently by each of the AMF 504 and the UE 501. At least one of these keys may be generated using another key, such as K_{AMF1}. The keys generated by the AMF may be provided to the first RAN node 502. The key generation may use analogous signalling to that described in, for example, Section 6 of 3GPP TS 33.501 V18.1.0.

During 5010, the AMF 504 signals the UE 501. This signalling may be a response to the signalling of 5002. This signalling may comprise, for example, a registration accept message.

The operations of 5001 to 5010 are performed in respect of a first 3GPP access. In contrast, the operations of 5011 to 5021 are performed in respect of a second 3GPP access.

During 5011, the UE 501 and the second RAN node 503 exchange signalling. This signalling may establish an RRC connection between the UE 501 and the second RAN node 503.

During 5012, the UE 501 signals the AMF 504. This signalling may comprise a registration request for registering the UE 501 with the home network 505. This registration request may comprise a second registration identifier. The first registration identifier may be different to the second registration identifier.

During 5013, the AMF 504 determines that the AMF 504 will trigger authentication for a second access with the home network 505 in response to the signalling of 5012. This determination may be based on, for example, the determination that the second registration identifier is different to the first registration identifier.

During 5014, the AMF 504 signals the home network 505. This signalling may comprise an authentication request for authenticating the UE 501. This signalling may comprise the second registration identifier.

During 5015, the home network 505 and the UE 501 exchange signalling. This signalling may comprise signalling for authenticating the UE 501 (e.g., signalling related to Authentication and Key Agreement (AKA)).

During 5016, the home network 505 signals the AMF 504. This signaling may comprise a response to the authentication request of 5014. For example, this signalling may indicate that the UE 501 has been authenticated.

During 5017, the UE 501 and the AMF 504 exchange signalling. This signalling may comprise signalling relating to a security procedure (e.g., to an NAS security procedure).

During 5018, as a result of the security procedure of 5017, each of the UE 501 and the AMF 504 are storing keys (e.g., K_{AMF2} and K_{NAS2}) resulting from the signalling of 5006. The keys stored at the first RAN node are generated by the AMF using K_{AMF2} and provided to the first RAN node.

During 5019, the UE 501 and the second RAN node 503 exchange signalling. This signalling may comprise signalling relating to an access stratum (AS) security procedure.

During 5020, the UE 501 and the second RAN node 503 each have keys stored (e.g., K_{gNB2}, K_{RRC2}, and K_{UP2}) resulting from the security procedure of 5019. These stored keys are different to the keys stored during 5009. At least one of these keys may be generated by the AMF 504 and the UE 501. At least one of these keys may be generated independently by each of the AMF 504 and the UE 501. At least one of these keys may be generated using another key, such as K_{AMF2}. The keys generated by the AMF may be provided to the second RAN node 502. The key generation may use analogous signalling to that described in, for example, Section 6 of 3GPP TS 33.501 V18.1.0.

During 5021, the AMF 504 signals the UE 501. This signalling may be a response to the signalling of 5012. This signalling may comprise, for example, a registration accept message.

In this example of FIG. 5, a UE and a first RAN apparatus establish an RRC connection. After the RRC connection is established, a registration request for the UE is sent to an AMF that comprises a first registration identifier (e.g., Reg Id=1) via a first 3GPP access that comprises the first RAN apparatus. The first RAN apparatus, a second RAN apparatus, and the AMF all belong to a first administrative domain (e.g., to PLMN #1). The home network and the UE perform an authentication that, when successful, causes NAS-related keys to be established. For example, when an AKA challenge is successful, and after an NAS security procedure, K_{AMF1} and K_{NAS}1 keys are generated. Later, an access stratus (AS) security procedure is executed. As part of this security procedure, the AMF generates a key (K_{gNB1}) for the first RAN apparatus and sends K_{gNB1} to the first RAN apparatus. The first RAN apparatus subsequently generates keys (K_{RRC1}, and K_{UP1}) for use via the first 3GPP access. The UE is subsequently sent a registration accept message using a newly assigned globally unique identifier (e.g., 5G-GUTI). The globally unique identifier for a UE may be an identifier assigned to that UE by an AMF that is common to both a 3GPP access network and to a non-3GPP access network. The globally unique identifier may be usable in each of a 3GPP access network and a non-3GPP access network for accessing security context within the assigning AMF for that UE.

Subsequently, the UE and the second RAN apparatus establish an RRC connection. After the RRC connection is established, a registration request for the UE is sent to the AMF that comprises a second registration identifier (e.g., Reg Id-2) via a second 3GPP access that comprises the second RAN apparatus. Based on the new Reg Id, the AMF decides to create a new security context for the same UE. As AMF would otherwise generate the same set of keys for both the first RAN apparatus and the second RAN apparatus, the AMF decides to signal a request for authentication towards home network. This results in a new AKA challenge being performed, and in new set of HN, SN and AN keys. The first RAN apparatus and the second RAN apparatus will consequently have different set of keys.

An AMF security context may therefore be associated (and/or identified by) a combination of a registration identifier and a subscription permanent identifier (SUPI). For example, after authentication is performed, the AMF may retrieve a SUPI associated with the UE from a unified data management (UDM), and store it. The UE may be identified by its SUPI (which may comprise, for example, the UE's international mobile subscriber identity (IMSI)).

In this first example, as two authentications are performed and two security contexts are maintained at the AMF level, resources may be wasted in relation to both the extra signalling and in relation to the storing of multiple keys and security contexts.

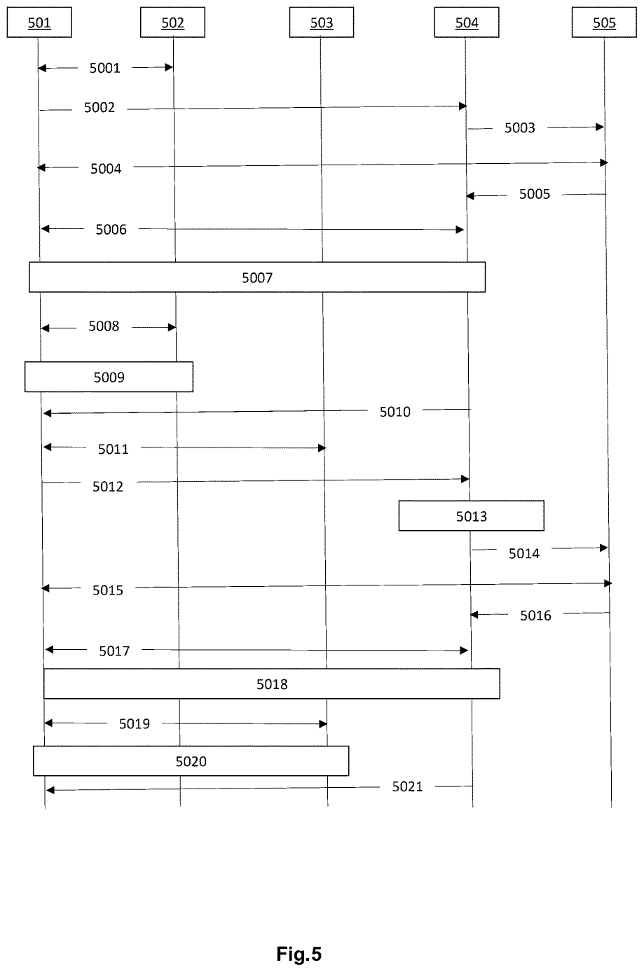

A second example for addressing at least one of the above-mentioned issues is described below and in relation to FIG. 6.

This second example relates to the expansion of the “Access Type Distinguisher” that is currently used for deriving certain AS keys such that secondary types of access networks are enabled. The AS keys may comprise keys related to any of a wireline access gateway function (K_{WAGF}), a trusted non-3GPP gateway function (K_{TNGF}), a trusted wireless local area network inter-working function (K_{TWIF}), a gNB (K_{gNB}), and/or a non-3GPP inter-working function (K_{N3IWF}), and their associated derivation functions.

For example, when AS keys are currently derived, a plurality of different inputs are inputted into an associated key derivation function (KDF). In particular, the keys K_{gNB}, K_{WAGF}, K_{TNGF}, K_{TWIF} and K_{N3IWF} are derived in the UE and the AMF using K_{AMF} and the uplink NAS COUNT. Currently, the following parameters are used to provide an input to an associated KDF for respectively obtaining these keys:
FC=0x6E.
P0=Uplink NAS COUNT
L0=length of uplink NAS COUNT (e.g., 0x00 0x04)
P1=Access type distinguisher
L1=length of Access type distinguisher (e.g., 0x00 0x01)

Where FC comprises a static value. These operations may be performed by at least an AMF.

Currently, the access type distinguisher used in these inputs is used to distinguish between a 3GPP access and a non-3GPP access. This is shown below in Table 1. The values 0x00 and 0x06 to Oxf0 are reserved for future use, and the values 0xf1 to 0xff are reserved for private use.

TABLE 1
Access type distinguishers

| Access type | |
|---|---|
| distinguisher | Value |
| 3GPP access | 0x01 |
| Non 3GPP access | 0x02 |

The example of FIG. 6 comprises expanding the current types of access type distinguishers to include support for indicating that the secondary access networks of a same type. These different/expanded values may therefore represent a different input that is used for determining the AS security context keys (e.g., any of K_{gNB}, K_{WAGF}, K_{TNGF}, K_{TWIF} and K_{N3IWF}).

The potential expanded values for the access type distinguisher are illustrated below in Table 2.

TABLE 2
Access type distinguishers

| Access type | |
|---|---|
| distinguisher | Value |
| 3GPP access | 0x01 |
| Non 3GPP access | 0x02 |
| 3GPP secondary | 0X03 |
| Access | |
| Non 3GPP secondary | 0X04 |
| Access | |
| 3GPP Satellite | 0X05 |
| Access | |

As shown in Table 2, the new access type distinguisher may be set to a value for (0x01), (0x03), or (0x05) for differing 3GPP accesses when deriving K_{gNB}. The access type distinguisher may be set to a value of (0x02), or (0x04) for differing non-3GPP accesses when deriving K_{N3IWF}, K_{WAGF}, K_{TWIF} or K_{TNGF}.

The input key used to derive these other values may be the 256-bit K_{AMF}.

This function is applied when cryptographically protected 5G radio bearers are established and when a key change on-the-fly is performed.

Therefore, in this second example, a UE and an AMF are configured with at least one new access type distinguisher.

When the UE signals a request for registration via the AMF, UE provides the UE's registration identifier to the AMF, where the registration identifier identifies the access network path used for signalling the registration request from the UE to the AMF. Based on the received registration identifier in the registration request, the AMF selects an access type distinguisher. For example, the UE may provide the AMF with a first access path identifier (Ref Id=1, and/or Leg Id=1) with the first registration request via the first access path, and may further provide the AMF with a second access path identifier (Ref Id=2, and/or Leg Id=2) with the second registration request via the second access path, where the first and second access paths are a same access type (e.g., both 3GPP or both non-3GPP).

For example, when the AMF receives a first registration identifier or no registration identifier is received, and the access type is 3GPP access, then the AMF selects the Access type distinguisher 0x01. Subsequently, when the AMF receives a second registration identifier and the access type is 3GPP access, then the AMF selects the access type distinguisher 0x03.

Similarly, when the AMF receives a second registration identifier and the access type is 3GPP satellite, then the AMF selects the access type distinguisher 0x05.

As another example, when the AMF receives a first registration identifier or no registration identifier is received, and the access type is non-3GPP access, then the AMF selects the Access type distinguisher 0x02. Subsequently, when the AMF receives a second registration identifier and the access type is non-3GPP access, then the AMF selects the access type distinguisher 0x05.

Consequently, based on the access type and UE connection, the UE and AMF may use values associated with each of the access type and UE connection for key generation.

This second example is illustrated with respect to FIG. 6.

FIG. 6 illustrates signalling that may be performed between a UE 601, a first RAN node 602, a second RAN node 603, an AMF 604, and a home network 605. The first and second RAN nodes are illustrated as belonging to a same PLMN. The first RAN node 602 is associated with a first 3GPP access. The second RAN node 603 is associated with a second 3GPP access.

During 6001, the UE 601 and the first RAN node 602 exchange signalling. This signalling may establish a radio resource control (RRC) connection between the UE 601 and the first RAN node 602.

During 6002, the UE 601 may signal the AMF 604. This signalling may comprise a registration request for registering with the home network 605. This registration request may comprise a first registration identifier.

During 6003, the AMF 604 signals the home network 605. This signalling may comprise an authentication request for authenticating the UE 601.

During 6004, the home network 605 and the UE 601 exchange signalling. This signalling may comprise signalling for authenticating the UE 601 (e.g., signalling related to Authentication and Key Agreement (AKA)).

During 6005, the home network 605 signals the AMF 604. This signaling may comprise a response to the authentication request of 6003. For example, this signalling may indicate that the UE 601 has been authenticated.

During 6006, the UE 601 and the AMF 604 exchange signalling. This signalling may comprise signalling relating to a security procedure (e.g., to an NAS security procedure). This signalling may determine that the first registration identifier is to be used.

During 6007, as a result of the security procedure of 6006, each of the UE 601 and the AMF 604 are storing keys (e.g., K_{AMF1} and K_{NAS1}) resulting from the signalling of 6006. Further, during 6007, the UE and the AMF select a same access type distinguisher for identifying that the first access type (e.g., 3GPP1).

During 6008, the UE 601 and the first RAN node 602 exchange signalling. This signalling may comprise signalling relating to an access stratum (AS) security procedure.

During 6009, the UE 601 and the first RAN node 602 each have keys stored (e.g., K_{gNB1}, K_{RRC}, and K_{UP}) resulting from the security procedure of 6008. The keys stored at the first RAN node are generated by the AMF using K_{AMF} and provided to the first RAN node. At least one of these keys may be generated by the AMF 604 and the UE 601. At least one of these keys may be generated independently by each of the AMF 604 and the UE 601. At least one of these keys may be generated using another key, such as K_{AMF}. The keys generated by the AMF may be provided to the first RAN node 602. The key generation may use analogous signalling to that described in, for example, Section 6 of 3GPP TS 33.501 V18.1.0.

During 6010, the AMF 604 signals the UE 601. This signalling may be a response to the signalling of 6002. For example, this signalling may comprise, for example, a registration accept message.

The operations of 6001 to 6010 are performed in respect of a first 3GPP access. In contrast, the operations of 6011 to 6018 are performed in respect of a second 3GPP access.

During 6011, the UE 601 and the second RAN node 603 exchange signalling. This signalling may establish an RRC connection between the UE 601 and the second RAN node 603.

During 6012, the UE 601 signals the AMF 604. This signalling may comprise a registration request for registering the UE 601 with the home network 605. This registration request may comprise a second registration identifier. The first registration identifier may be different to the second registration identifier.

During 6013, the AMF 604 and the UE determine to use the previously generated NAS context. The AMF 604 therefore does not trigger authentication for a second access network with the home network 605.

During 6014, the AMF 604 and the UE exchange signalling. This signalling may comprise signalling relating to a security procedure (e.g., to an NAS security procedure). This signalling may confirm that the second registration identifier is to be used for deriving access stratum security context between the UE and the second RAN node.

During 6015, the UE and the AMF select a same access type distinguisher for identifying that the second access type (e.g., 3GPP2) using the second registration identifier. In the present example, this may set the Access Type distinguisher=3.

During 6016, the UE 601 and the second RAN node 603 exchange signalling. This signalling may comprise signalling relating to an access stratum (AS) security procedure.

During 6017, the UE 601 and the second RAN node 603 each have keys stored (e.g., K_{gNB2}, K_{RRC}, and K_{UP}) resulting from the security procedure of 6016. At least one of these stored keys is different to the keys stored during 6009. The keys stored at the second RAN node are generated by the AMF using K_{AMF} and provided to the second RAN node. At least one of these keys may be generated by the AMF 604 and the UE 601. At least one of these keys may be generated independently by each of the AMF 604 and the UE 601. At least one of these keys may be generated using another key, such as K_{AMF}. The keys generated by the AMF may be provided to the first RAN node 602. The key generation may use analogous signalling to that described in, for example, Section 6 of 3GPP TS 33.501 V18.1.0 (although it is understood that an input value for determining K_{gNB2} may differ during 6017 relative to the mechanism described in 3GPP TS 33.501, as the access type identifier used for calculating this key may take a new value to indicate that the second RAN node is of a same access type as the first RAN node).

During 6018, the AMF 604 signals the UE 601. This signalling may be a response to the signalling of 6012. This signalling may comprise, for example, a registration accept message.

In this example of FIG. 6, a UE and a first RAN node establish an RRC connection. After the RRC connection is established, a registration request for the UE is sent to the AMF with the first registration identifier (e.g., Reg Id=1) via the first 3GPP access network. The first RAN node, the second RAN node, and the AMF all belong to a same administrative domain (e.g., PLMN #1). Based on the provision of the first registration identifier, the AMF and the UE select an access type distinguisher (e.g., =1) and generate AS keys.

Subsequently, the UE and the second RAN node establishes an RRC connection. After the RRC connection is established, the UE sends a registration request to the AMF that comprises the second registration identifier (e.g., Reg-id=2) via the second 3GPP access network. Based on the provision of the second registration identifier, the AMF and UE selects an access type distinguisher=3 and generates new AS keys accordingly.

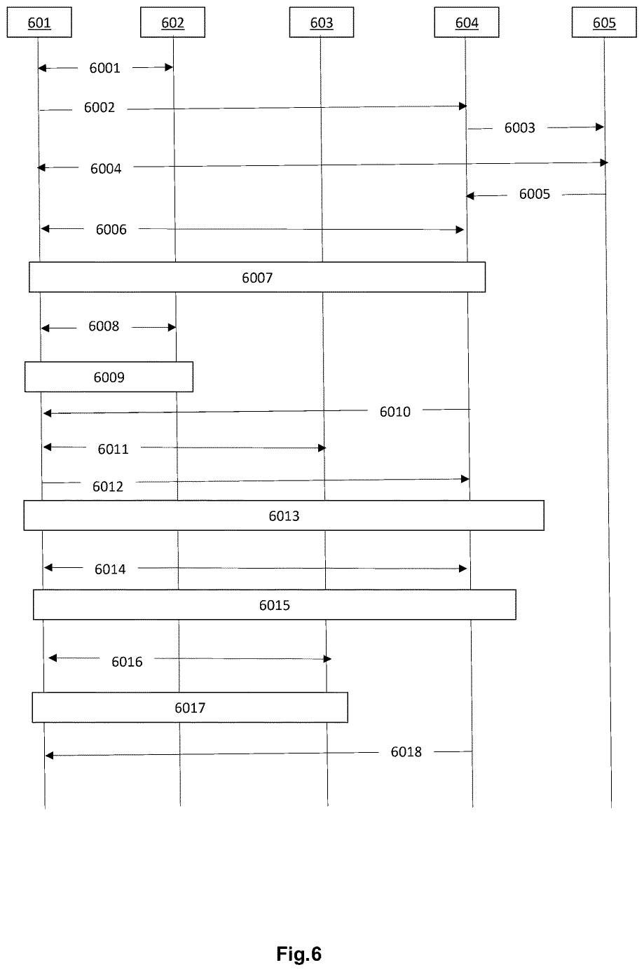

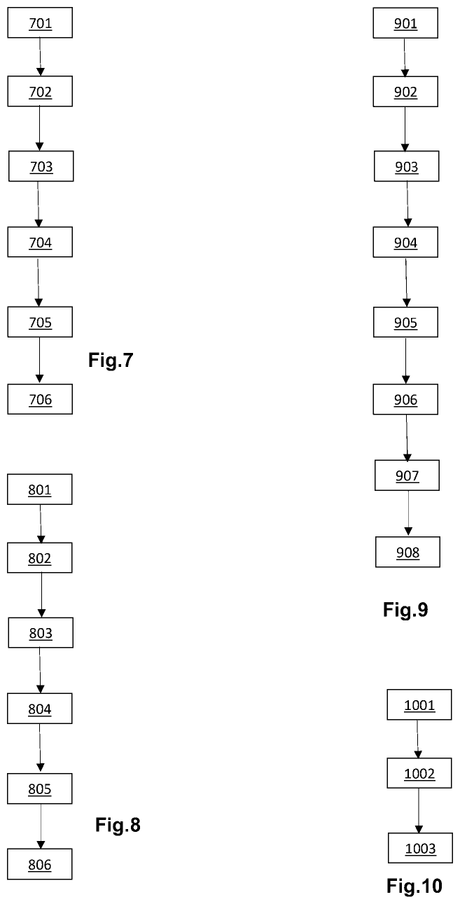

FIGS. 7 to 10 illustrate elements of the above examples. It is therefore understood that the following described features may find functional correspondence in at least one of the above-described examples. It is further understood that the above-described examples may provide further context for how the presently described principles may be implemented in certain examples.

The examples of FIGS. 7 and 8 may relate to operations illustrated in relation to the second example mentioned above.

FIG. 7 illustrates operations that may be performed by an apparatus (e.g., a network apparatus). The apparatus may comprise an access and mobility management function (AMF). The apparatus may be comprised in an access and mobility management function. The apparatus may comprise a virtual network function (VNF) instance of an access and mobility management function.

During 701, the apparatus exchanges first signalling with a user equipment, the first signalling comprising a first access path identifier that identifies a first access path between the user equipment and the apparatus.

During 702, the apparatus exchanges second signalling with the user equipment, the second signalling comprising a second access path identifier that identifies a second access path between the user equipment and the apparatus, the first and second access paths providing dual access between the user equipment and a network. The first and second access paths may exchange signalling between the user equipment and the network.

During 703, the apparatus determines that the first and second access paths are associated with a first access type. For example, the first access type may comprise a 3GPP access type (e.g., 3GPP access and/or 3GPP satellite access). The first access type may comprise a non-3GPP access type.

During 704, the apparatus respectively assigns first and second access type identifiers to the first and second access paths based on the determining and the first and second access path identifiers.

For example, the first access type identifier may indicate that the first access path is an access path associated with the first access type and the second access type identifier may indicate that the second access path is an access path associated with the first access type (e.g., they are both 3GPP (whether 3GPP satellite and/or regular 3GPP) or both non-3GPP).

For example, using the above-mentioned examples, the apparatus may signal the first access path identifier (e.g., Reg Id=1) and select/assign first access type identifier/distinguisher=0x01, and the apparatus may signal the second access path identifier (e.g., Reg Id=2) and select/assign second access type identifier/distinguisher=0x03. This selection/assignment may be performed independently of the selection/assignment performed by the apparatus of FIG. 8.

During 705, the apparatus uses the first access type identifier to generate a first key for use with signalling on the first access path.

During 706, the apparatus uses the second access type identifier to generate a second key for use with signalling on the second access path.

The apparatus may provide the first key to a first access node associated with the first access path, and may provide the second key to a second access node associated with the second access path.

The first access node (e.g., a gNB and/or a TNGF and/or similar) may use the first key to derive at least one other key for use in ciphering, and/or integrity protection of signalling between the first access node and the user equipment, and/or for verification of the UE and/or the first access node.

The second access node (e.g., a gNB and/or a TNGF and/or similar) may use the second key to derive at least one other key for use in ciphering, and/or integrity protection of signalling between the second access node and the user equipment, and/or for verification of the UE and/or the second access node.

The first and second keys may be independently generated by the apparatus. Each of the first and second keys may be respectively generated using a key associated with the apparatus (e.g., K_{AMF}) and the respective access type identifiers. For example, the first key may be generated by inputting at least K_{AMF} and the first access type identifier into a key derivation function and obtaining the first key as an output. Further, the second key may be generated by inputting at least K_{AMF} and the second access type identifier into a key derivation function and obtaining the second key as an output.

The first key may comprise an access network node key (e.g., K_{gNB}). The first key may comprise a trusted non-3GPP gateway function key (e.g., K_{TNGF} or similar, as discussed above in relation to FIG. 6). The second key may comprise an access network node key (e.g., K_{gNB}). The second key may comprise a trusted non-3GPP gateway function key (e.g., K_{TNGF} or similar, as discussed above in relation to FIG. 6).

In this example of FIG. 7, the apparatus may, in response to receiving the first signalling, initiate an authentication operation with a home network in respect of the user equipment. The apparatus may abstain from initiating an authentication operation with the home network in response to receiving the second signalling.

The apparatus may establish a non-access stratum security context for the UE in response to receiving the first signalling and/or receiving signalling on the first access path. The signalling may abstain from establishing a non-access stratum security context for the UE in response to receiving the second signalling and/or receiving signalling on the second access path. Instead, the apparatus may re-use the NAS security context established for the UE in respect of the first signalling (and/or first access path) for the UE over the second access path. Stated differently, the apparatus may maintain (e.g., cause to be stored) a single NAS security context for use with both the first and second access paths when dual access over both access paths is to be performed.

FIG. 8 illustrates operations that may be performed by an apparatus. The apparatus may comprise a user equipment.

During 801, the apparatus exchanges first signalling with a network apparatus, the first signalling comprising a first access path identifier that identifies a first access path between the network apparatus and the apparatus. The network apparatus may comprise the apparatus of FIG. 7. The first signalling may be signalled via a first access node (e.g., a first gNB) on the first access path.

During 802, the apparatus exchanges second signalling with the network apparatus, the second signalling comprising a second access path identifier that identifies a second access path between the network apparatus and the apparatus, the first and second access paths providing dual access between the apparatus and a network.

During 803, the apparatus determines that the first and second access paths are associated with a first access type. For example, the first access type may comprise a 3GPP access type (e.g., 3GPP terrestrial access and/or 3GPP satellite access). The first access type may comprise a non-3GPP access type.

During 804, the apparatus respectively assigns first and second access type identifiers to the first and second access paths based on the determining and the first and second access path identifiers.

For example, the first access type identifier may indicate that the first access path is an access path associated with the first access type and the second access type identifier may indicate that the second access path is an access path associated with the first access type (e.g., they are both 3GPP (whether 3GPP satellite and/or terrestrial 3GPP) or both non-3GPP).

For example, using the above-mentioned examples, the apparatus may signal the first access path identifier (e.g., Reg Id=1) and select/assign first access type identifier/distinguisher=0x01, and the apparatus may signal the second access path identifier (e.g., Reg Id=2) and select/assign second access type identifier/distinguisher=0x03. This selection/assignment may be performed independently of the selection/assignment performed by the apparatus of FIG. 7.

During 805, the apparatus uses the first access type identifier to generate a first key for use with signalling on the first access path.

During 806, the apparatus uses the second access type identifier to generate a second key for use with signalling on the second access path.

The apparatus may use the first key or at least one key derived from the first key for ciphering and/or integrity protection of signalling with a first access node (e.g., a gNB and/or a TNGF and/or similar) on the first access path, and/or verification of at least one of the apparatus or the first access node.

The apparatus may use the second key or at least one key derived from the second key for ciphering and/or integrity protection of signalling with a second access node (e.g., a gNB and/or a TNGF and/or similar) on the second access path, and/or verification of at least one of the apparatus or the second access node.

The first and second keys may be independently generated by the apparatus. Each of the first and second keys may be respectively generated using a key associated with the network apparatus (e.g., K_{AMF}) and the respective access type identifiers. For example, the first key may be generated by inputting at least K_{AMF} and the first access type identifier into a key derivation function and obtaining the first key as an output. Further, the second key may be generated by inputting at least K_{AMF} and the second access type identifier into a key derivation function and obtaining the second key as an output.

The first key may comprise an access network node key (e.g., K_{gNB}). The first key may comprise a trusted non-3GPP gateway function key (e.g., K_{TNGF} or similar, as discussed above in relation to FIG. 6). The second key may comprise an access network node key (e.g., K_{gNB}). The second key may comprise a trusted non-3GPP gateway function key (e.g., K_{TNGF} or similar, as discussed above in relation to FIG. 6).

The apparatus may maintain (e.g., cause to be stored) a single NAS security context for use with both the first and second access paths when dual access over both access paths is to be performed.

The examples of FIGS. 9 and 10 may relate to operations illustrated in relation to the first example mentioned above.

FIGS. 9 and 10 illustrate operations that may be performed by an apparatus (e.g., a network apparatus). The apparatus may comprise an access and mobility management function (AMF). The apparatus may be comprised in an access and mobility management function. The apparatus may comprise a virtual network function (VNF) instance of an access and mobility management function.

During 901, the apparatus exchanges first signalling with a user equipment, the first signalling comprising a first access path identifier that identifies a first access path between the user equipment and the apparatus.

During 902, the apparatus causes the user equipment to be authenticated to obtain a first security key for the user equipment along the first access path. Using the example of FIG. 5, this first security key may comprise K_{AMF1}. The first security key may be associated with a first security context (e.g., a first NAS security context). The first security context may therefore be associated with the first access path.

For example, the apparatus may trigger a home network to authenticate the user equipment over the first access path while the user equipment.

During 903, the apparatus may exchange second signalling with the user equipment, the second signalling comprising a second access path identifier that identifies a second access path between the user equipment and the apparatus, the first and second access paths providing dual access between the user equipment and a network.

During 904, the apparatus may determine that the first and second access paths are associated with a first access type.

During 905, the apparatus may determine to cause authentication to be performed over the second access based on the second access path identifier.

For example, the apparatus may trigger a home network to authenticate the user equipment over the second access path while the user equipment is already authenticated over the first access path.

For example, the apparatus may determine that even though the first and second access paths are of a same type (and are to be used simultaneously (e.g., for dual access)), that separate security authentication operations are to be performed with a home network for each access path for establishing respective security contexts for the first and second access paths.

Consequently, during 906, the apparatus causes the user equipment to be authenticated to obtain a second security key for the user equipment along the second access path. Using the example of FIG. 5, this second security key may comprise K_{AMF2}. The second security key may be associated with a second security context (e.g., a second NAS security context). The second security context may therefore be associated with the second access path.

During 907, the apparatus uses the first security key to generate a first key for use with signalling on the first access path. Using the example of FIG. 5, the first key may comprise K_{gNB1} and/or K_{TNGF1} and/or some similar key for AS security context over the first access path.

During 908, the apparatus uses the second security key to generate a second key for use with signalling on the second access path. Using the example of FIG. 5, the second key may comprise K_{gNB2} and/or K_{TNGF2} and/or some similar key for AS security context over the second access path.

The apparatus may provide the first key to a first access node associated with the first access path.

The apparatus may provide the second key to a second access node associated with the second access path.

The apparatus may simultaneously maintain the first security key as part of a first security context for the user equipment and the second security key as part of a second security context for the user equipment.

The apparatus may establish a first non-access stratum security context for the UE in response to receiving the first signalling and/or receiving signalling on the first access path. The signalling may establish a second non-access stratum security context for the UE in response to receiving the second signalling and/or receiving signalling on the second access path. Stated differently, the apparatus may establish and maintain (e.g., store) respective (and different) NAS security contexts for each of the first and second access paths. These different NAS security contexts may be used for obtaining respective access node keys for their access paths.

FIG. 10 illustrates operations that may be performed by any of a user equipment and/or an AMF discussed in relation to FIG. 5.

During 1001, the apparatus establishes a first security context with another apparatus over a first access path between the another apparatus and the apparatus. This may be performed as a result of first signalling being signalled over the first access path that identifies the first access path and that causes the apparatus or the another apparatus to be authenticated.

During 1002, the apparatus establishes a second security context with the another apparatus over a second access path between the another apparatus and the apparatus, wherein the first and second access paths are associated with a same access type. This may be performed as a result of second signalling being signalled over the second access path that identifies the second access path and that causes the apparatus or the another apparatus to be authenticated.

During 1003, the apparatus simultaneously maintains the first and second security contexts.

The first and second security contexts may be NAS security contexts.

The first and second security contexts may be access stratum security contexts.

The apparatus may determine a first key for use with signalling a first access node associated with the first access path using the first security context (e.g. using a first security key comprised in the first security context). The apparatus may determine a second key for use with signalling a second access node associated with the second access node (e.g. using a first security key comprised in the first security context).

When the apparatus is an AMF and the another apparatus is a UE, the apparatus may provide the first and/or second key to, respectively, the first and/or second access nodes.

When the apparatus is a UE and the another apparatus is an AMF, the apparatus may use the first and/or second key to derive respective keys for ciphering and/or integrity protecting signalling to the first and/or second access nodes.

In all of the above examples, the first signalling may be for establishing a first non-access stratum security context, and/or the second signalling may be for establishing a second non-access stratum security context.

In all of the above examples, the first access path type may be at least one of: 3GPP, or non-3GPP. The 3GPP access path type may comprise a “regular” (e.g., terrestrial) 3GPP access type and/or a 3GPP satellite access.

The first access path identifier may be at least one of: a registration identifier or a leg identifier or any other identifier (e.g., at least one other identifier that uniquely identifies an access path).

The second access path identifier may be at least one of: a registration identifier or a leg identifier or any other identifier (e.g., at least one other identifier that uniquely identifies an access path).

The first and second access paths may belong to a same administrative domain. For example, the first and second access paths may belong to a same PLMN. The first and second access paths may belong to a same non-public network.

An access path may comprise a signalling route between a UE and a network. For example, an access path may be identified by an access node that provides access between the UE and the network.

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the claims.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

As provided herein, various aspects are described in the detailed description of examples and in the claims. In general, some examples may be implemented in hardware or special purpose circuits, software code, logic or any combination thereof. For example, some aspects may be implemented in hardware, while other aspects may be implemented in firmware or software code which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software code, firmware code, special purpose circuits or logic, general purpose hardware or controller or other computing devices, or some combination thereof.

The examples may be implemented by computer software code stored in a memory and executable by at least one data processor of the involved entities or by hardware, or by a combination of software code and hardware.

The memory referred to herein may be of any type suitable to the local technical environment and may be implemented using any suitable data storage technology, such as semiconductor based memory devices, magnetic memory devices and systems, optical memory devices and systems, fixed memory and removable memory.

The (data) processors referred to herein may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Further in this regard it should be noted that any procedures, e.g., as in FIG. 7, and/or FIG. 8, and/or FIG. 9 and/or FIG. 10, and/or otherwise described previously, may represent operations of a computer program being deployed by at least one processor comprised in an apparatus (where a computer program comprises instructions for causing an apparatus to perform at least one action, the instructions being represented as software code stored on at least one memory), or interconnected logic circuits, blocks and functions, or a combination of operations of a computer program being deployed by at least one processor comprised in an apparatus and logic circuits, blocks and functions. The software code may be stored on transitory or non-transitory memory, such as physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” or “means” may refer to one or more or all of the following:
(a) hardware-only circuit implementations (such as implementations in only analogue and/or digital circuitry);
(b) combinations of hardware circuits and software cade, such as:
   (i) a combination of analogue and/or digital hardware circuit(s) with software/firmware code and
   (ii) any portions of hardware processor(s) with software code (including digital signal processor(s)), software code, and memory (ies) that work together to cause an apparatus, such as the communications device or base station to perform the various functions previously described; and
(c) hardware circuit(s) and or processor(s), such as a microprocessor(s) or a portion of a microprocessor(s), that requires software code (e.g., firmware) for operation, but the software code may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware code. The term circuitry also covers, for example integrated device.

Implementations of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “non-transitory,” as used herein, is a limitation of the medium itself (i.e., tangible, not a signal) as opposed to a limitation on data storage persistency (e.g., RAM vs. ROM).

The scope of protection sought for various examples of the disclosure is set out by the independent claims. The examples and features, if any, described in this specification that do not fall under the scope of the independent claims are to be interpreted as examples useful for understanding the disclosure.

The foregoing description has provided by way of non-limiting examples a full and informative description of example implementations of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further implementation comprising a combination of one or more implementations with any of the other implementations previously discussed.

1-27. (canceled)

28. An apparatus comprising: at least one processor; and at least one memory storing instructions that, when executed by the at least one processor, cause the apparatus at least to perform:
exchanging first signaling with a user equipment, the first signaling comprising a first access path identifier that identifies a first access path between the user equipment and the apparatus;
exchanging second signaling with the user equipment, the second signaling comprising a second access path identifier that identifies a second access path between the user equipment and the apparatus, the first and second access paths providing dual access between the user equipment and a network;
determining that the first and second access paths are associated with a same access type;
respectively assigning first and second access type identifiers to the first and second access paths based on the determining, and the first and second access path identifiers;
using the first access type identifier to generate a first key for use with signaling on the first access path; and
using the second access type identifier to generate a second key for use with signaling on the second access path.

29. The apparatus of claim 28, wherein the apparatus further comprises an access and mobility management function.

30. The apparatus of claim 28, wherein the instructions, when executed by the at least one processor, further cause the apparatus at least to perform:
providing the first key to a first access node associated with the first access path; and
providing the second key to a second access node associated with the second access path.

31. An apparatus comprising: at least one processor; and at least one memory storing instructions that, when executed by the at least one processor, cause the apparatus at least to perform:
exchanging first signaling with a network device, the first signaling comprising a first access path identifier that identifies a first access path between the network device and the apparatus;
exchanging second signaling with the network device, the second signaling comprising a second access path identifier that identifies a second access path between the network device and the apparatus, the first and second access paths providing dual access between the apparatus and a network;
determining that the first and second access paths are associated with a same access type;
respectively assigning first and second access type identifiers to the first and second access paths based on the determining, and the first and second access path identifiers;
using the first access type identifier to generate a first key for use with signaling on the first access path; and
using the second access type identifier to generate a second key for use with signaling on the second access path.

32. The apparatus of claim 31, wherein the instructions, when executed by the at least one processor, further cause the apparatus at least to perform:
using the first key or at least one other key derived from the first key for ciphering and integrity protection of signaling with a first access node on the first access path.

33. The apparatus of claim 31, wherein the instructions, when executed by the at least one processor, further cause the apparatus at least to perform:
using the first key or at least one other key derived from the first key for ciphering or integrity protection of signaling with a first access node on the first access path.

34. The apparatus of claim 31, wherein the instructions, when executed by the at least one processor, further cause the apparatus at least to perform:
using the second key or at least one other key derived from the second key for ciphering or integrity protection of signaling with a second access node on the second access path.

35. The apparatus of claim 31, wherein the apparatus is a user equipment.

36. An apparatus, comprising: at least one processor; and at least one memory storing instructions that, when executed by the at least one processor, cause the apparatus at least to perform:
exchanging first signaling with a user equipment, the first signaling comprising a first access path identifier that identifies a first access path between the user equipment and the apparatus;
causing the user equipment to be authenticated to obtain a first security key associated with the first access path;
exchanging second signaling with the user equipment, the second signaling comprising a second access path identifier that identifies a second access path between the user equipment and the apparatus, the first and second access paths providing dual access between the user equipment and a network;
determining that the first and second access paths are associated with a same access type;
determining to cause the user equipment to be authenticated over the second access path based on the second access path identifier;
causing the user equipment to be authenticated to obtain a second security key associated with the second access path;
using the first security key to generate a first key for use with signaling on the first access path; and
using the second security key to generate a second key for use with signaling on the second access path.

37. The apparatus as claimed in claim 36, wherein the apparatus comprises an access and mobility management function.

38. The apparatus of claim 36, wherein the instructions, when executed by the at least one processor, further cause the apparatus at least to perform:
providing the first generated key to a first access node associated with the first access path; and
providing the second generated key to a second access node associated with the second access path.

39. The apparatus of claim 36, wherein the instructions, when executed by the at least one processor, further cause the apparatus at least to perform:
maintaining the first security key as part of a first security context for the user equipment, and the second security key as part of a second security context for the user equipment.

40. The apparatus of claim 36, wherein the first signaling is for establishing a first non-access stratum security context, and the second signaling is for establishing a second non-access stratum security context.

41. The apparatus of claim 36, wherein the first access path identifier is at least one of: a registration identifier or a leg identifier.

42. The apparatus of claim 36, wherein the second access path identifier at least one of: a registration identifier or a leg identifier.
